(19) United States
(12) Patent Application Publication
(10) Pub. No.: US 2023/0206692 A1
(43) Pub. Date: Jun. 29, 2023

(54) METHOD AND APPARATUS FOR GENERATING A SENTIMENT SCORE FOR CUSTOMERS

(71) Applicant: Uniphore Technologies, Inc., Palo Alto, CA (US)

(72) Inventors: Saurabh Saxena, San Jose, CA (US); Mario Gomez, Valencia (ES); Varsha Lodha, Palo Alto, CA (US)

(21) Appl. No.: 18/116,289

(22) Filed: Mar. 1, 2023

Related U.S. Application Data
(63) Continuation-in-part of application No. PCT/US2022/053909, filed on Dec. 23, 2022.
(60) Provisional application No. 63/293,659, filed on Dec. 23, 2021.
(60) Provisional application No. 63/315,526, filed on Mar. 1, 2022.

(51) Int. Cl. G06V 40/16; G06Q 30/01

(52) U.S. Cl. CPC G06V 40/176; G06Q 30/01

(57) ABSTRACT

A method and an apparatus for generating a cumulative sentiment score includes a method comprising receiving, at an analytics server, for a first event having a first plurality of participants includes a customer, video data and audio data for the customer, extracting, for the customer, at least one of tonal information or text information from the audio data, and facial expression information from video data, determining, from the at least one of the facial expression information, the tonal information or the text information, a first sentiment score for the customer for the first event, and generating a first event graphic displaying an association between the first sentiment score and at least one deal parameter for the first event, where the at least one deal parameter is associated with a deal includes the first event.

### CROSS-REFERENCE TO RELATED APPLICATIONS

This application claims priority to the International Patent Application No. PCT/US2022/053909 filed on 23 Dec. 2022, which claims priority to the U.S. Provisional Pat. Application Serial No. 63/293,659, filed on 23 Dec. 2021, and U.S. Provisional Pat. Application Serial No. 63/315,526, filed on 1 Mar. 2022, each of which is incorporated by reference herein.

### FIELD

The present invention relates generally to video and audio processing, and specifically to generating a sentiment score for customers in sales environments.

### BACKGROUND

Several business and non-business meetings are now conducted in a multimedia mode, for example, web-based audio and video conferences including multiple participants. Reviewing such multimedia meetings, in which significant amount of data, different modes of data is shared and presented, to identify key information therefrom has proven to be cumbersome and impractical. While there exists a wealth of information regarding various participants in such meetings, it has been difficult to extract meaningful information from such meetings.

Accordingly, there exists a need in the art for techniques for generating a sentiment score for customers.

### SUMMARY

The present invention provides a method and an apparatus for generating a sentiment score for customers, substantially as shown in and/or described in connection with at least one of the figures, as set forth more completely in the claims. These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates an apparatus for generating a sentiment score for customers, according to one or more embodiments.

FIG. 2 illustrates the analytics server of FIG. 1, according to one or more embodiments.

FIG. 3 illustrates the user device of FIG. 1, according to one or more embodiments.

FIG. 4 illustrates a method for assessing participation in a multi-party communication, for example, as performed by the apparatus of FIG. 1, according to one or more embodiments.

FIG. 5 illustrates a method for identifying key moments in a multi-party communication, for example, as performed by the apparatus of FIG. 1, according to one or more embodiments.

FIG. 6 illustrates a method for generating hyper-relevant text keyphrases, according to one or more embodiments.

FIG. 7 illustrates a method for identifying impact of hyper-relevant text keyphrases, according to one or more embodiments.

FIG. 8 illustrates a method for generating a sentiment score for customers, according to one or more embodiments.

FIG. 9 illustrates a user interface for assessing participation in a multi-party communication, according to one or more embodiments.

FIG. 10 illustrates a user interface for assessing participation in a multi-party communication, according to one or more embodiments.

FIG. 11 illustrates a user interface for assessing participation in a multi-party communication, according to one or more embodiments.

FIG. 12 illustrates a user interface depicting a sentiment score for customers, according to one or more embodiments.

### DETAILED DESCRIPTION

Embodiments of the present invention relate to a method and an apparatus for generating a sentiment score for customers, for example, from multiple multimedia or audio sales calls (or meetings or events) between the salesperson and potential or actual customers. During a sales call, for example, with one or more customers or participants, interactions of a salesperson, for example, audio data of the salesperson, and optionally video data of the salesperson if the interaction is a multimedia call, are captured. Tonal and text information are extracted from audio data, while vision information is extracted from video data. Behavioral parameters, such as empathy, stress, politeness, hesitation, among others are extracted from one or more of the tonal, text or vision information, and the behavioral parameters are used to determine a sentiment score for the customer in one sales call, multiple sales calls for a deal, and all deals or calls for an organization, or any other grouping for such calls. Performance scores determined over several such sales calls of the salesperson with same or different customers or potential customers are combined to compute a cumulative performance score (CPS) for the salesperson.

Participation is broadly assessed by assessing the engagement, and the sentiment and/or emotion of the participants, for example, during the call, after the call, and as a group including some or all participants. For brevity, sentiment and/or emotion is referred to collectively as “sentiment” hereon. The conference call video is processed to extract visual or vision data, for example, facial expression analysis data, and the audio is processed to extract tonal data and optionally text data, for example, text transcribed from the speech of the participants. The multiple modes of data from the meeting, viz., vision data, tonal data and optionally text data (multi-modal data) is used, for example, by trained artificial intelligence and/or machine learning (AI/ML) models or algorithmic models, to assess several parameters for each participant. The assessment based on multiple modes of data is then fused or combined on a time scale to generate fused data or a representative participation score (RPS), which includes a score for engagement and a score for sentiment of each participant. The RPS scores are aggregated for each participant for the entire meeting, and for all participants for the entire meeting. In some embodiments, the RPS is computed in real time for each participant based on vison and tonal data for immediate recent data, while after the call, the RPS is computed for each participant based on vision, tonal and text data for the entire meeting. In some embodiments, a list of highly relevant terms is used in conjunction with text data to identify impact on sentiment or engagement of the participants for a particular meeting, or over several meetings with same or different participants.

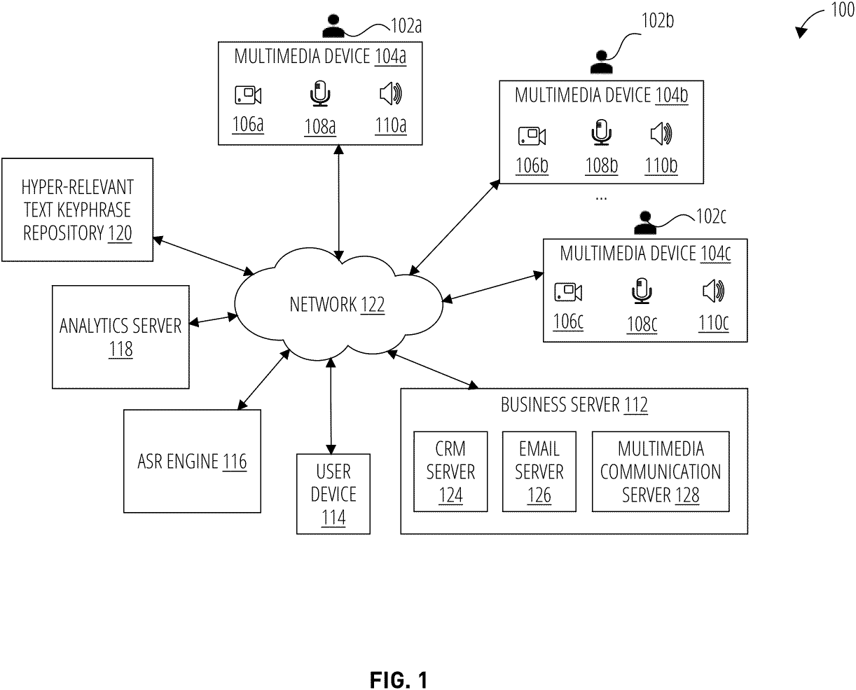

FIG. 1 is a schematic representation of an apparatus 100 for generating a sentiment score for customers, according to one or more embodiments of the invention. FIG. 1 shows a participant 102a who is a representative of a business, for example, a salesperson, in a discussion with the business’ customers, for example, the participants 102b and 102c (together referred to by the numeral 102), who are representatives of the customer), each of the participants 102 using components of the apparatus 100. The apparatus 100 includes all components shown in FIG. 1, and do not include the participants themselves. While only a limited number of salesperson(s) and customer(s) or customer representatives are shown, it is understood that there may be more or less number of salespersons and/or customers or customer representatives. Each participant 102 is associated with a multimedia device 104a, 104b, 104c (together referred to by the numeral 104) via which each participant communicates with others in the multi-party communication or a meeting. For example, such meetings are enabled by ZOOM VIDEO COMMUNICATIONS, INC. of San Jose, CA, MICROSOFT CORPORATION of Redmond, WA, WEBEX by CISCO Systems of Milpitas, CA, among several other similar web-based or other multimedia/videoconferencing providers. Each of the multimedia devices 104a, 104b, 104c is a computing device, such as a laptop, personal computer, tablet, smartphone or a similar device that includes or is operably coupled to a camera 106a, 106b, 106c, a microphone 108a, 108b, 108c, and a speaker 110a, 110b, 110c, respectively, and additionally includes a graphical user interface (GUI) to display the ongoing meeting, or a concluded meeting, and analytics thereon. In some embodiments, two or more participants 102 may share a multimedia device to participate in the meeting. In such embodiments, the video of the meeting is used for generating the facial expression analysis data, and the audio of the meeting is used to generate tonal and/or text data for all the participants sharing the multimedia device, for example, using techniques known in the art. The apparatus 100 also includes a business server 112, a user device 114, an automatic speech recognition (ASR) engine 116, an analytics server 118, and a hyper-relevant text keyphrase (HRTK) repository 120. Various elements of the apparatus 100 are capable of being communicably coupled via a network 122 or via other communication links as known in the art, and are coupled as and when needed.

The business server 112 provides services such as customer relationship management (CRM) server 124, email server 126, multimedia communication server 128 providing multimedia meetings include, for example, audio and video meetings between the participants 102, for example, employees of the business and of the business’ customer(s). In some embodiments, the business server 112 is configured to use one or more third party services. The business server 112 is configured to extract data, for example, from any of the services it provides, and provide it to other elements of the apparatus 100, for example, the user device 114, the ASR engine or the analytics server 118. For example, the business server 112 may send audio and or video data captured by the multimedia devices 104 to the elements of the apparatus 100.

The user device 114 is an optional device, usable by persons other than the participants 102 to view the meeting with the assessment of the participation generated by the apparatus 100. In some embodiments, the user device 114 is similar to the multimedia devices 104.

The ASR engine 116 is configured to convert speech from the audio of the meeting to text, and can be a commercially available engine or proprietary ASR engines. In some embodiments, the ASR engine 116 is implemented on the analytics server 118.

The analytics server 118 is configured to receive the multi-modal data from the meeting, for example, from the multimedia devices 104 directly or via the business server 112, and process the multi-modal data to determine or assess participation in a meeting or multiple meetings.

The HRTK repository 120 is a database of key phrases identified or predefined as relevant to an industry, domain or customers.

The network 122 is a communication Network, such as any of the several communication Networks known in the art, and for example a packet data switching Network such as the Internet, a proprietary Network, a wireless GSM Network, among others.

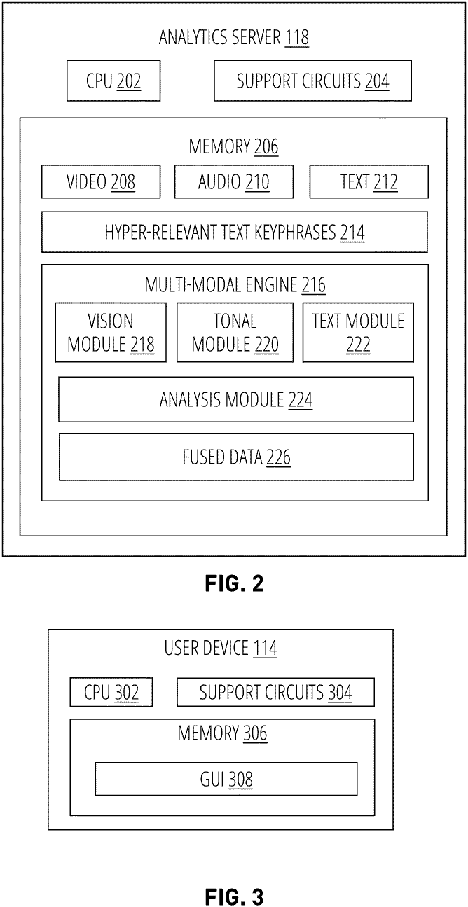

FIG. 2 is a schematic representation of the analytics server 118 of FIG. 1, according to one or more embodiments. The analytics server 118 includes a CPU 202 communicatively coupled to support circuits 204 and a memory 206. The CPU 202 may be any commercially available processor, microprocessor, microcontroller, and the like. The support circuits 204 comprise well-known circuits that provide functionality to the CPU 202, such as, a user interface, clock circuits, network communications, cache, power supplies, I/O circuits, and the like. The memory 206 is any form of digital storage used for storing data and executable software. Such memory includes, but is not limited to, random access memory, read only memory, disk storage, optical storage, and the like. The memory 206 includes computer readable instructions corresponding to an operating system (OS) (not shown), video 208, audio 210 and text 212 corresponding to the meeting. In some embodiments, the text 212 is extracted from the audio 210, for example, by the ASR engine 116. The video 208, the audio 210 and the text 212 (e.g., from ASR engine 116) is available as input, either in real-time or in a passive mode. The memory 206 further includes hyper-relevant text key phrases (HRTKs), for example, obtained from the HRTK repository 120.

The memory 206 includes a multi-modal engine (MME) 216 including a vision module 218, a tonal module 220, a text module 222, an analysis module 224 and fused data 226. Each of the modules 218, 220 and 222 for vision, tonal and text data extract respective characteristics therefrom, and analyzed by the analysis module 224 to generate metrics of participation, for example, engagement and sentiment of the participants, in the meeting. In some embodiments, the analysis module 224 combines the analyzed data from the multiple modes (vision, tonal and optionally text) to generate fused data 226, which is usable to provide one or more representative participation scores, such as sentiment scores and engagement scores for a participant, and for the meeting, and identify key moments in the meeting. In some embodiments, the analysis module 224 is also configured to generate hyper-relevant text keyphrases for industries, domains or companies, for example, from various public sources.

FIG. 3 is a schematic representation of the user device 114 of FIG. 1, according to one or more embodiments. The user device 114 includes a CPU 302 communicatively coupled to support circuits 304 and a memory 306. The CPU 302 may be any commercially available processor, microprocessor, microcontroller, and the like. The support circuits 304 comprise well-known circuits that provide functionality to the CPU 302, such as, a user interface, clock circuits, network communications, cache, power supplies, I/O circuits, and the like. The memory 306 is any form of digital storage used for storing data and executable software. Such memory includes, but is not limited to, random access memory, read only memory, disk storage, optical storage, and the like. The memory 306 includes computer readable instructions corresponding to an operating system (OS) (not shown), and a graphical user interface (GUI) 308 to display one or more of a live or recorded meeting, and analytics with respect to participation thereon or separately. The user device 114 is usable by persons other than participants 102 while the meeting is ongoing or after the meeting is concluded. In some embodiments, the multimedia devices 104 are similar to the user device 114 in that each includes a GUI similar to the GUI 308, and each multimedia device also includes a camera, a microphone and a speaker for enabling communication between the participants during the meeting.

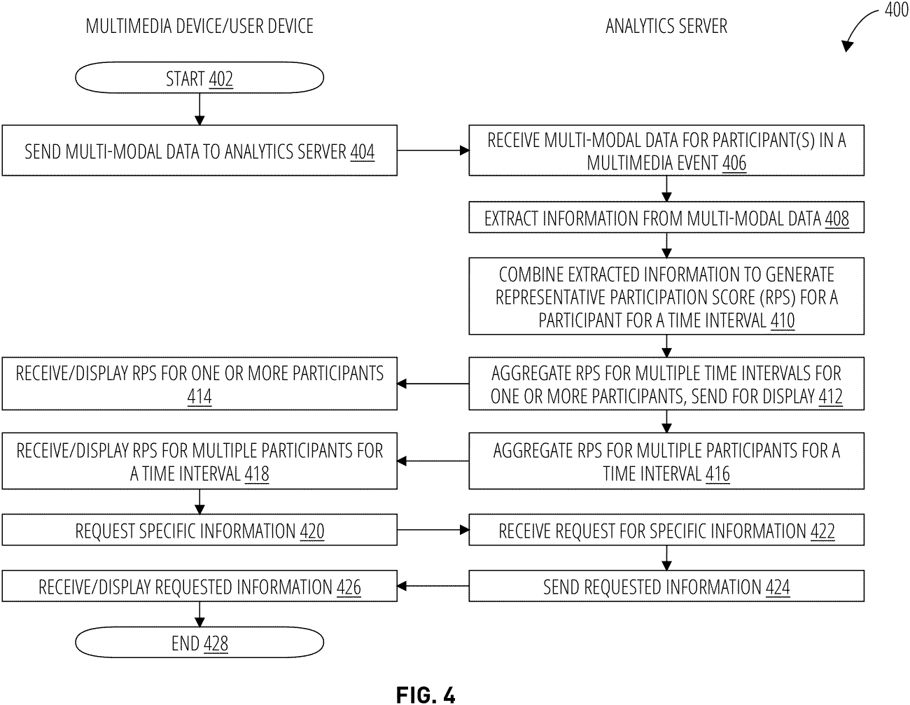

FIG. 4 illustrates a method 400 for assessing participation in a multi-party communication, for example, as performed by the apparatus 100 of FIG. 1, according to one or more embodiments. In some embodiments, steps of the method 400 performed on the analytics server 118 are performed by the MME 216. The method 400 starts at step 402, and proceeds to step 404, at which the multi-modal data (the video and audio data) of the meeting is sent from a multimedia device, for example, one or more of the multimedia devices 104 to the analytics server 118, directly or, for example, via the business server 112. In some embodiments, the multi-modal data is sent live, that is streamed, and in other embodiments, the data is sent in batches of configurable predefined time duration, such as, the entire meeting or short time bursts, for example, 5 seconds.

At step 406, the method 400 receives the multi-modal data for the participant(s) from the multimedia device(s) at the analytics server 118, and at step 408, the method 400 extracts information from each of the multi-modal data. For example, from the video 208 data, the vision module 218 extracts vision parameters for participation for each participant using facial expression analysis and gesture tracking. The parameters include facial expression based sentiments, head nods, disapprovals, among others. From the audio 210 data, the tonal module 220 extracts tonal parameters , which include tone based sentiments, self-awareness parameters such as empathy, politeness, speaking rate, talk ratio, talk over ratio, among others. From the text 212 data, obtained using the audio 210 data by the ASR engine 116, the text module 222 extracts text parameters, which include text-derived sentiments, among others. Sentiments extracted from any of the modes include one or more of happiness, surprise, anger, disgust, sadness, fear, among others.

In some embodiments, extraction of the vision, tonal and text parameters is performed using known techniques. For example, the facial expression analysis and gesture tracking is performed by the vision module 218 by tracking a fixed number of points on each face in each video frame, or a derivative thereof, for example, the position of each point in each frame averaged over a second. In some embodiments, 24 frames are captured in each second, and about 200 points on the face are tracked in each frame, the position of which may be averaged for a second to determine an average value of such points for a second. This facial expression analysis data is used as input by the vision module 218 to determine the vision parameters. In some embodiments, the vision module 218 includes one or more AI/ML models to generate an output of the vision parameters. The AI/ML model(s) of vision module 218 is/are trained using several images of faces and sentiment(s) associated therewith, using known techniques, which enables the vision module 218 to predict or determine the sentiments for an input image of the face for each participant 102. In some embodiments, the vision module 218 includes a finite computational model for determining a sentiment of a participant based on an input image of the face of each participant 102. In some embodiments, the vision module 218 includes a combination of one or more AI/ML models and/or finite computation models. The tonal module 220 analyzes the waveform input of the audio 210 to determine the tonal parameters. The tonal module 220 may include AI/ML models, computational models or both. The text module 222 analyzes the text 212 to determine text parameters, and includes sentiment analyzers as generally known in the art.

In some embodiments, each of the models 218, 220, 222 are configured to determine parameters for the same time interval on the time scale of the meeting. In some embodiments, each of the models 218, 220, 222 are configured to generate a score for corresponding parameters. In addition to determining the corresponding parameters, in some embodiments, one or more of the vision module 218, the tonal module 220 and the text module 222 generate a confidence score associated with the determined parameter to indicate a level of confidence or certainty regarding the accuracy of the determined parameter.

The method 400 proceeds to step 410, at which the method 400 combines extracted information to generate representative participation scores (RPS) for a participant for a given time interval. For example, the time interval is a second, and the method 400 generates the RPS for each second of the meeting. In some embodiments, the RPS is a combination of the scores for the vision parameters, the tonal parameters and the text parameters. In some embodiments, the scores for the vision parameters, the tonal parameters and the text parameters are normalized and then averaged to generate participation scores, that is a score for sentiment and a score for engagement, for each participant for each time interval, for example, 1 second. As used herein, participation is assessed by assessing the engagement and/or the sentiment of participants and correspondingly, the RPS include a score for engagement and a score for sentiment. In some embodiments, some parameters are used to compute the score for engagement, while some other parameters for sentiment. The parameters used for engagement may or may not overlap with the parameters used for sentiment. In some embodiments, vision parameters such as head position with respect to a camera and all the landmark points on the face near the eye are used to determine engagement score, while other landmark points around the eye and cheeks and eyebrows area are used to determine sentiment score.

In some embodiments, the scores for the vision parameters, the tonal parameters and the text parameters are co-normed first and a weighted score is generated for engagement and for sentiment, that is the RPS. In some embodiments, an assessment is made, based on the confidence scores of each of the vision, tonal or text data, as to the certainty thereof, and the weightage of such mode is increased. In some embodiments, the mode having a confidence score below a predefined threshold, or a predefined threshold below the confidence score of other mode is ignored (weight = 0). In this manner, the vision, tonal and text data for a predefined time interval of the meeting is combined or fused to generate fused data 226 for the predefined time interval, for example, a second.

At step 412, the method 400 aggregates RPS for multiple time intervals for one participant, for example, a portion of or the entire duration of the meeting. In such instances, the RPS, which includes scores for engagement and/or sentiment represents the engagement levels and/or sentiment of the participant during such time intervals. At step 416, the method 400 aggregates RPS for multiple participants over one or more time intervals, such as a portion of or the entire duration of the meeting. In such instances, the RPS represents the engagement levels and/or the sentiment of the participants for the time intervals. The number of participants, duration and starting point of time intervals is selectable, for example, using a GUI on the multimedia devices 104 or the user device 114. The aggregation may be performed by calculating a simple average over time and/or across participants, or using other statistical techniques known in the art.

One or more of the steps 406-416 discussed above may be performed after the meeting is complete, that is, in a passive mode. In some embodiments, steps 406-412 are performed in real time, that is, as soon as practically possible within the physical constraints of the elements of the apparatus 100, and in such embodiments, only the vision and tonal data is processed, and the text data is not extracted or processed to generate the RPS. Further, the RPS is generated based on a prior short time interval preceding the current moment, for example, the RPS for an instance takes into account previous 5 seconds of vision and tonal data. In this manner, in the real-time mode, the RPS represents a current participation trend of a participant or a group of participants.

In some embodiments, the RPS for one or more participants 102 and/or a group of participants or all participants, for each second, or a portion of the meeting or the entire meeting is sent for display, for example, on the GUI 308 of the user device 114, or the GUI(s) of the multimedia devices, or any other device configured with appropriate permission and communicably coupled to the network 122. At steps 414 or 418, such devices receive and display the RPS on a GUI, for example, in the context of a recorded playback or live streaming of the meeting.

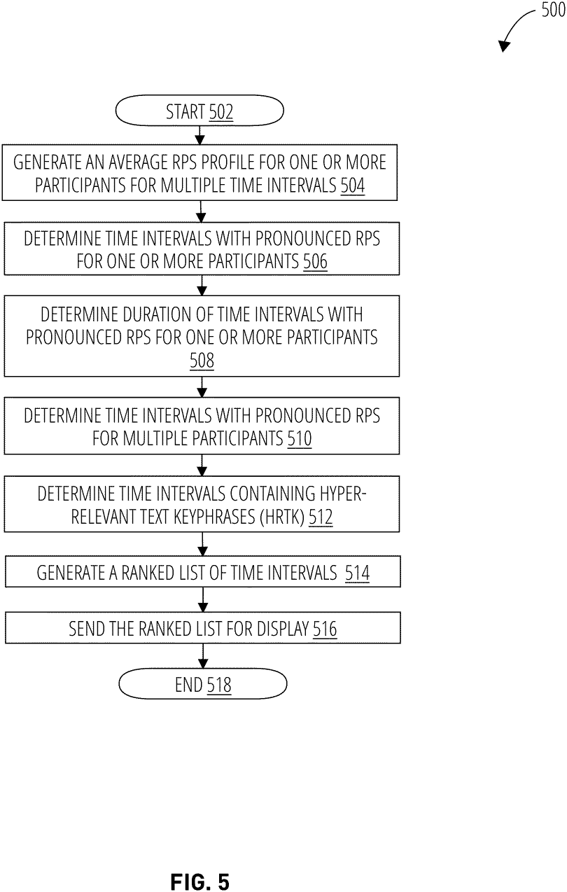

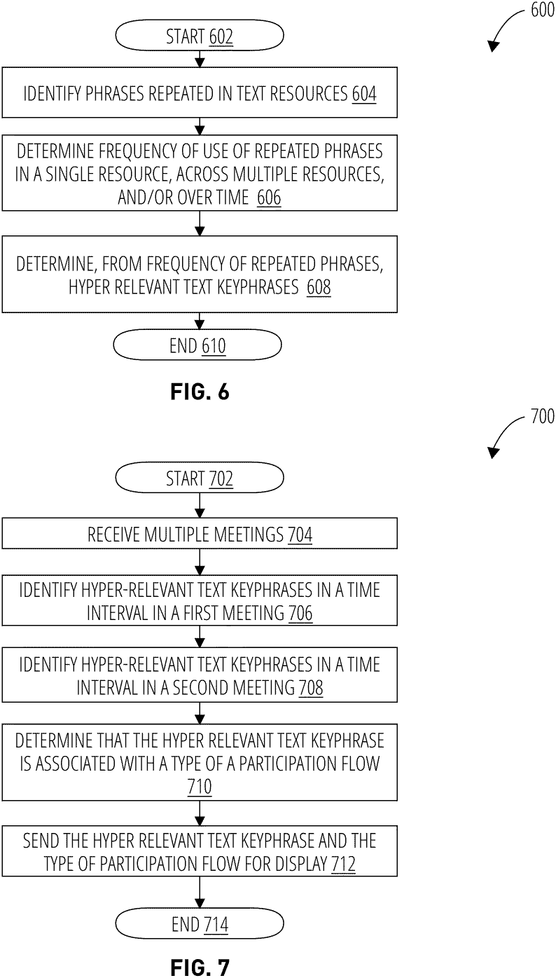

In some embodiments, at step 420, participants or other users may request specific information from the analytics server 118, for example, via the GUI in multimedia devices 104 or the GUI 308 of the user device 114. The specific information may include RPS for specific participant(s) for specific time duration(s), or any other information based on the fused data 226, RPS or constituents thereof, and information based on other techniques, for example, methods of FIG. 5 and FIG. 6. Upon receiving the request at step 422, the analytics server 118 sends the requested information to the requesting device at step 424, which receives and displays the information at step 426. The method 400 proceeds to step 428, at which the method 400 ends.

The techniques discussed herein are usable to identify a customer’s participation, a business team’s participation or the overall participation. Further, while a business context is used to illustrate an application of techniques discussed herein, the techniques may be applied to several other, non-business contexts.

FIG. 5 illustrates a method 500 for identifying key moments in a multi-party communication, for example, as performed by the apparatus 100 of FIG. 1, according to one or more embodiments. In some embodiments, steps of the method 500 are performed by the MME 216.

The method 500 starts at step 502 and proceeds to step 504, at which the method 500 generates an average RPS profile for one or more participants over a portion of the meeting or the entirety of the meeting, and in some embodiments, the method 500 generates an average RPS profile for each participant for the entirety of the meeting. The average RPS profile represents a baseline sentiment and/or engagement levels of a participant. For example, one participant may naturally be an excited, readily smiling person, while another may naturally have a serious and stable demeanor, and the average RPS profile accounts for the participant’s natural sentiment and engagement levels throughout the meeting, and provides a baseline to draw a comparison with.

At step 506, the method 500 identifies or determines time intervals for which RPS of one or more participants has a pronounced movement, for example, time intervals in which the RPS increases or decreases substantively with respect to the average RPS profile for a given participant. A pronounced movement with respect to the average RPS profile indicates a significant change in the sentiment and/or engagement of the participant, and a potentially important time interval(s) in the meeting for that participant. The pronounced movement could be defined as movement in the RPS (difference between the RPS for a moment and the average RPS for a participant) greater than a predefined threshold value.

Steps 504 and 506 help identify important moments for participants based on the participant averaged engagement throughout the meeting. In some embodiments however, the step 504 is not performed, and step 506 determines pronounced movement by comparing a movement of the RPS over time, greater than a predefined threshold. That is, if the RPS of a participant increases (or decreases) more than a predefined threshold value compared to a current RPS within a predefined time interval, for example, 10 seconds, then such time intervals are identified as potentially important time interval(s) for that participant. The time intervals determined at step 506, whether using the averaged RPS score according to step 504 or using absolute movement in the RPS score without using the step 504, are referred to as ‘swings’ in the participation.

At step 508, the method 500 determines the time intervals for which the pronounced movement of the RPS is sustained for one or more participants, for example, for a time duration greater than a predefined threshold. Such time intervals are referred to as ‘profound’ swings.

At step 510, the method 500 determines the time intervals with swings and/or profound swings for multiple participants that overlap or occur at the same time, that is, time intervals in which more than one participant had a pronounced RPS movement, or pronounced RPS movement for a sustained duration of time. Multiple participants having swings and/or pronounced swings in the same or proximate time intervals indicate a mirroring of participation of one or some participant(s) by one or other participant(s). Such time intervals are referred to as ‘mirrored’ swings. Mirrored swings include swings in the RPS of one participant in the same or opposite direction, that is other participants may exhibit similar reaction or opposite reactions to the one participant.

At step 512, the method 500 determines, from time intervals identified at steps 506 (swings), 508 (pronounced swings) and/or step 510 (mirrored swings), the time intervals that contain one or more instances of phrases from a list of predefined phrases that are considered relevant to an industry, domain, company/business or any other parameter. Such phrases are referred to as hyper-relevant text keyphrases (HRTKs) and the time intervals are referred to as blended key moments.

Any of the time intervals identified at steps 506 (swings), 508 (pronounced swings), 510 (mirrored swings) or 512 (blended key moments) are identified as important moments of the meeting, or moments that matter, and at step 514, one or a combination of the swings, pronounced swings, mirrored swings or blended key moments are ranked. In some embodiments, only one type of swings, for example, the pronounced swings, or the mirrored swings or the pronounced and mirrored swings are ranked. Ranking is done according to the quantum of swing, that is, according to the movement of the RPS for the time intervals, cumulated for all or some participants. In some embodiments, the cumulation is performed by summation, averaging, or another statistical model, to arrive at the quantum of movement (or the swing) of the RPS. The time intervals or moments are ranked high if the quantum of the movement of the RPS is high, and lower if the quantum of the movement of the RPS is lower.

At step 516, the method 500 sends the ranked list to a device for display thereon, for example, a device remote to the analytics server 118, such as the multimedia devices or the user device 114. In some instances, the ranked list is sent upon a request received from such a device. The ranked list identifies the portions of the meeting that are considered important. The method 500 proceeds to step 518, at which the method 500 ends.

While the method 500 discusses techniques to identify moments that matter in a single meeting, in some embodiments, blended key moments are identified in moments across different meetings involving the same participants, business or organization, or any other common entity, for example, a customer company treated as an “account” by a provider company selling to the customer company, and a “deal” with the “account” takes several meetings over several months to complete the deal. Blended key moments identified in different meetings held over time are used to identify HRTKs that persistently draw a pronounced or swing reaction from participants. For example, such blended key moments across different meetings are used to identify terms that induced negative, neutral or positive reactions, and based on identification of such terms, propositions that are valuable, factors that were considered negative or low impact, among several other inferences are drawn.

FIG. 6 illustrates a method 600 for generating hyper-relevant text keyphrases, according to one or more embodiments. In some embodiments, the method 600 is performed by the analysis module 224 of FIG. 1, however, in other embodiments, other devices or modules may be utilized to generate the HRTKs, including sourcing HRTKs from third party sources.

The method 600 starts at step 602, and proceeds to step 604, at which the method 600 identifies phrases repeated in one or more text resources, for example, websites, discussion forums, blogs, transcripts of conversations (voice or chat) or other sources of pertinent text. At step 606, the method 600 identifies the frequency of occurrence of such phrases repeated in a single resource across multiple resources, and/or resources made available over time. In step 608, determine, from the frequency of repeated phrases, hyper relevant keyphrases. The method 600 proceeds to step 610, at which the method ends.

In some embodiments, step 604 is performed ongoingly on existing and new text resources to update hyper-relevant text keyphrases (HRTKs) dynamically. In some embodiments, the HRTK repository 120 is updated dynamically after performing step 604, for example, by the analysis modules 224. In some examples, HRTK repository 120 is updated by a third party service, or similar other services.

FIG. 7 illustrates a method 700 for identifying impact of hyper-relevant text keyphrases, for example, as performed by the apparatus 100 of FIG. 1, according to one or more embodiments. In some embodiments, steps of the method 700 are performed by the MME 216. The method 700 starts at step 702, and proceeds to step 704, at which the method 700 receives multiple meetings (recordings thereof), for example, two or more meetings. At step 706, the method 700 identifies time intervals or moments from a first meeting including a hyper relevant text keyphrase (HRTK), and at step 708, the method 700 identifies time intervals or moments from a second meeting, different from the first meeting, including the same HRTK. The first and second meetings may have a common theme, for example, same business, industry, domain, or others, and may or may not have the same participants. Further, in some embodiments, multiple time intervals may be identified in the first and/or the second meeting.

At step 710, the method 700 determines a participation (sentiment and/or engagement) flow (positive, negative, neutral or tending thereto) during the moments identified from the first and the second meetings. For example, if during the identified moments of the first meeting and the second meeting, the participation flow is positive, it is determined that the HRTK is associated with a positive participation flow. Similarly, if during the identified moments of the first meeting and the second meeting, the participation flow is negative or neutral, it is determined that the HRTK is associated with a negative or neutral participation flow, respectively. In case of inconsistent participation flows identified in two or more time intervals associated with the same HRTK, conflict resolution mechanisms are used to arrive at a participation flow. For example, in some embodiments, conflict resolution is based on one or more factors such as recency (selecting a more recent time interval over older one), participant profile (selecting meetings and/or intervals attended by higher profile participants based on job titles), frequency (selecting a keyphrases associated with more of one type of sentiment, and fewer of other type of sentiments, over the keyphrases that are less frequently associate with that kind of sentiment) among others.

At step 712, the method 700 sends the HRTK and the participation flow identified at step 710 for display, for example, to a device remote to the analytics server 118, such as the multimedia devices or the user device 114. In some instances, the HRTK and the participation flow is sent upon a request received from such a device. The method 700 proceeds to step 714, at which the method 700 ends.

In this manner, HRTKs associated with specific type of participation (sentiment/engagement) are identified. Such an identification is usable to change or refine the use of such HRTKs.

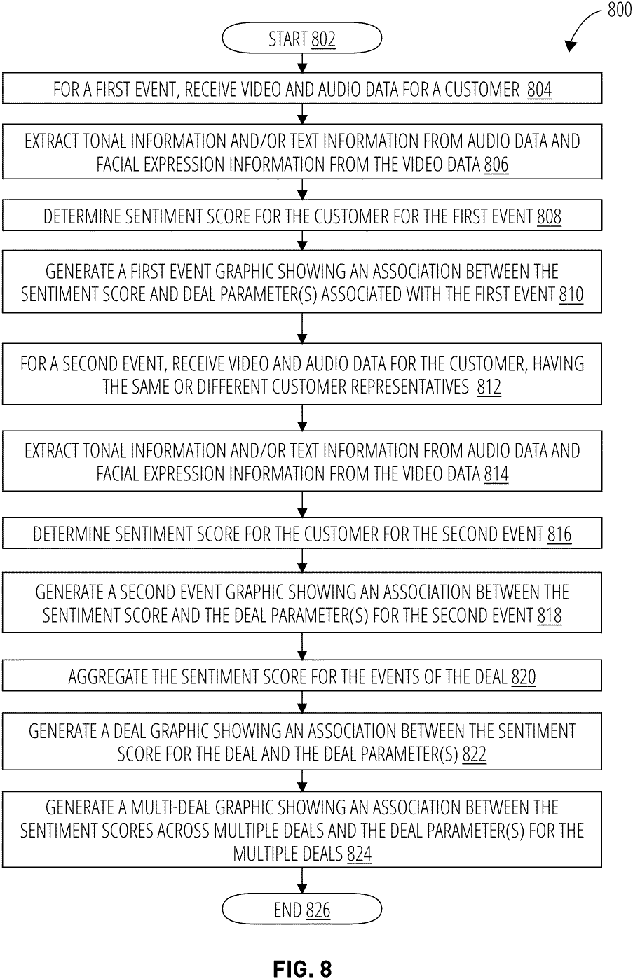

FIG. 8 illustrates a method 800 for generating a sentiment score for customers, for example, as performed by the apparatus 100 of FIG. 1, according to one or more embodiments. In some embodiments, steps of the method 800 are performed by the MME 216.

The method 800 starts at step 802, and proceeds to step 804, at which the method 800 receives video and audio data for a customer, for a first event. For example, the first event is a meeting from a possible several meetings over a business transaction or deal, such as a sales proposal, between one or more representative(s) of a selling organization or business, and one or more representative(s) of a customer organization. If multiple customer representatives are participate in the meeting, the video and audio data is received for one or more of the multiple customer representatives, referred to as the customer hereinafter, unless otherwise apparent from context.

At step 806, the method 800 extracts tonal information and/or text information from audio data and facial expression information from the video data, for the customer for the first event. At step 808, the method 800 determines a sentiment score for the customer for the first event based on the tonal, text and facial expression information or any combination thereof, for example, using techniques discussed herein or as known in the art.

The customer may include one or multiple customer representatives, and the sentiment score for the customer is an aggregate of the sentiment score for the multiple customer representatives, for example, an average of the sentiment scores for the multiple customer representatives. In some embodiments, weightage of the sentiment score of one or more of the multiple customer representatives for the customer can be increased or decreased while determining the aggregated sentiment score. In some embodiments, the weightage is increased or decreased by receiving an input from one of the business’ representatives (salesperson(s)) present in the meeting, for example, using the respective multimedia devices, or by any business’ representative, including those present or not present in the meeting, for example, using the user device 114. In some embodiments, the weightage is increased or decreased based on information about a customer representative, for example, using CRM data (designation, role in the deal, and the like) received from a CRM system, for example, the CRM server 124.

At step 810, the method 800 generates a first event graphic showing an association between the sentiment score and deal parameter(s) for the first event, which is a part of a deal. The deal parameter(s) associated with the deal includes a deal success metric, such as a win percentage, a time metric, such as a deal cycle, a deal completion percentage, among other deal related metrics as known in the art.

At step 812, the method 800 receives, for a second event or meeting associated with the deal, video and audio data for the customer. At step 814, the method 800 extracts tonal information and/or text information from audio data and facial expression information from the video data for the customer for the second event, and at step 816, the method 800 determines a sentiment score for the customer for the second event.

The customer may include the same or different representatives, including a higher or lower number thereof, in the second event as compared to the first event. There may be one or more common customer representatives in the first event and the second event, or no common customer representatives therebetween. The sentiment score for the customer is determined as an aggregate of the sentiment score for the multiple customer representatives, for example, as discussed above.

At step 818, the method 800 generates a second event graphic showing an association between the sentiment score and the deal parameter(s) associated with the second event.

At step 820, the method 800 aggregates the sentiment score for all the events of the deal, for example, sentiment scores the first event and the second event. In some embodiments, the aggregating of the sentiment score includes weighing the sentiment scores of the first event and the second event differently. For example, one of the meetings may be considered more important than others because of the content that was discussed, or the participants, especially from the customer side, such as a decision maker. In some embodiments, the differential weighing performed based on an input received from one of the business’ representatives (salesperson(s)) present in the meeting, for example, using the respective multimedia devices, or by any business’ representative, including those present or not present in the meeting, for example, using the user device 114. In some embodiments, the weightage is increased or decreased based on information about one or more customer representatives, for example, using CRM data (designation, role in the deal, and the like) received from a CRM system, for example, the CRM server 124.

At step 822, the method 800 includes generating a deal graphic showing an association between the sentiment score for the deal and deal parameter(s) associated with the first deal. At step 824, the method 800 generates a multi-deal graphic showing an association between the sentiment scores in multiple deals and deal parameter(s) associated with the multiple deals.

The method 800 proceeds to step 826, at which the method 800 ends.

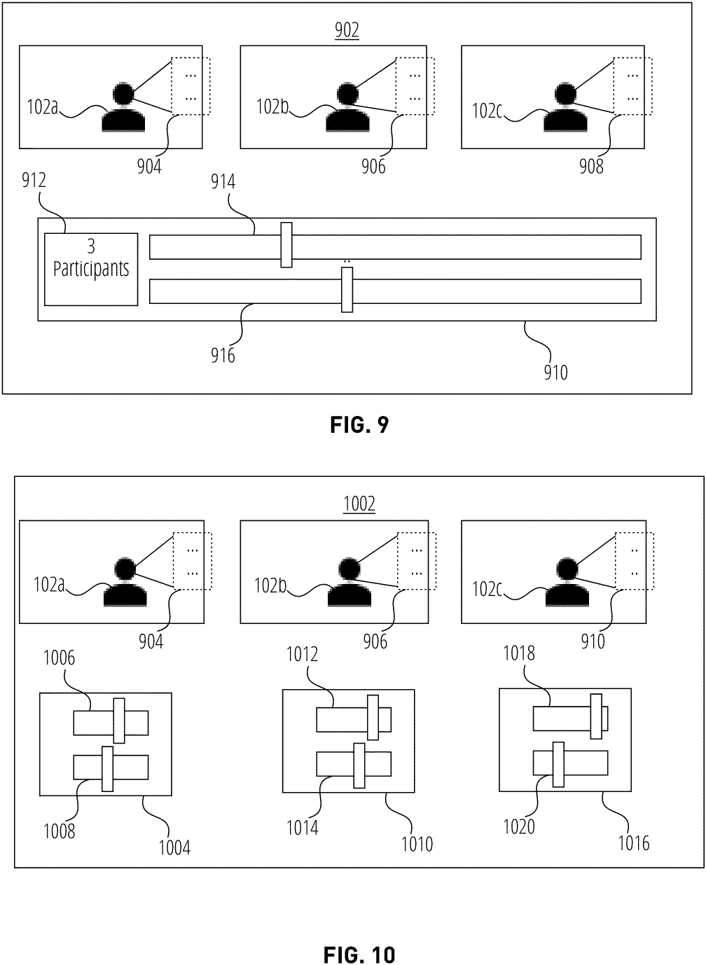

FIG. 9 illustrates a graphical user interface (GUI) 902 displayed on a display of a device, such as a multimedia devices or user device, for assessing participation in a multi-party communication, according to one or more embodiments. The GUI 902 shows participation summary, such as the representative participation scores (RPS), for example, the engagement score and the sentiment score, for each of the participants 102a, 102b, 102c in elements, 904, 906 and 908, respectively. Further, a GUI element 910 shows the cumulative RPS 912 for the meeting, and may include a separate and varying sentiment score 914 and engagement score 916 for the entire meeting. The various inputs for generating the output of the GUI 902 are generated using the techniques discussed above, and are sent to the multimedia devices and/or the user device 114 from the analytics server 118.

Similar to FIG. 9, FIG. 10 illustrates a graphical user interface (GUI) 1002 displayed on a display of a device, such as a multimedia devices or user device, for assessing participation in a multi-party communication, according to one or more embodiments. The GUI 1002 shows participation summary, such as the representative participation scores (RPS), for example, the engagement score and the sentiment score, for each of the participants 102a, 102b, 102c in elements, 904, 906 and 908, respectively. Further, GUI elements 1006 (and 1008, 1010), 1010 (and 1012, 1014) and 1016 (and 1018, 1020) show the respective sentiment and engagement scores for each of the participants 102a, 102b, 102c, respectively. The various inputs for generating the output of the GUI 1002 are generated using the techniques discussed above, and are sent to the multimedia devices and/or the user device 114 from the analytics server 118.

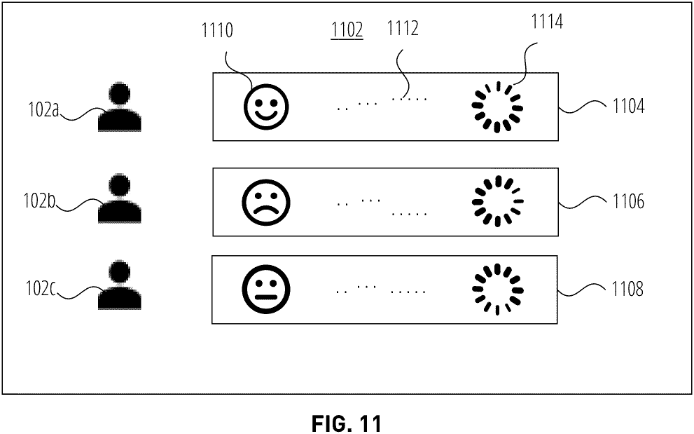

FIG. 11 illustrates a graphical user interface GUI 1102 for assessing participation in a multi-party communication according to one or more embodiments. The GUI 1102 shows summary of participation for each of the participants 102a, 102b, 102c in GUI elements 1104, 1106 and 1108, respectively, after the meeting has concluded. Each of the GUI elements, for example, the GUI element 1104 includes a sentiment score/representation 1110, a sentiment score flow 1112, and an engagement score/representation 1114. The GUI 1102 shows a helpful summary for each participant after the meeting. The various inputs for generating the output of the GUI 1102 are generated using the techniques discussed above, and are sent to the multimedia devices and/or the user device 114 from the analytics server 118.

Several recorded meetings are available over time, and various techniques described herein are further supplemented by cumulated tracking data for each of the participants, organization(s) thereof, a topic (e.g., a deal) of a meeting, keywords, among other unifying themes, in a meeting or across different meetings. Several other graphic representations using the RPS scores and assessment/analysis of participation (sentiment and engagement) performed in real time and/or after conclusion of the meeting are contemplated herein, such as overlaying the RPS scores and/or analysis over a recording or a live streaming playback of the meeting, for moments that matter for a participant, or multiple participants, and for presenting hyper-relevant text key phrases associated with specific sentiments in a meeting or across different meetings. Further, in some embodiments including real time computations, time delays may be introduced in the computation, for example, to perform computation on aggregated data, to present aggregated information, among other factors.

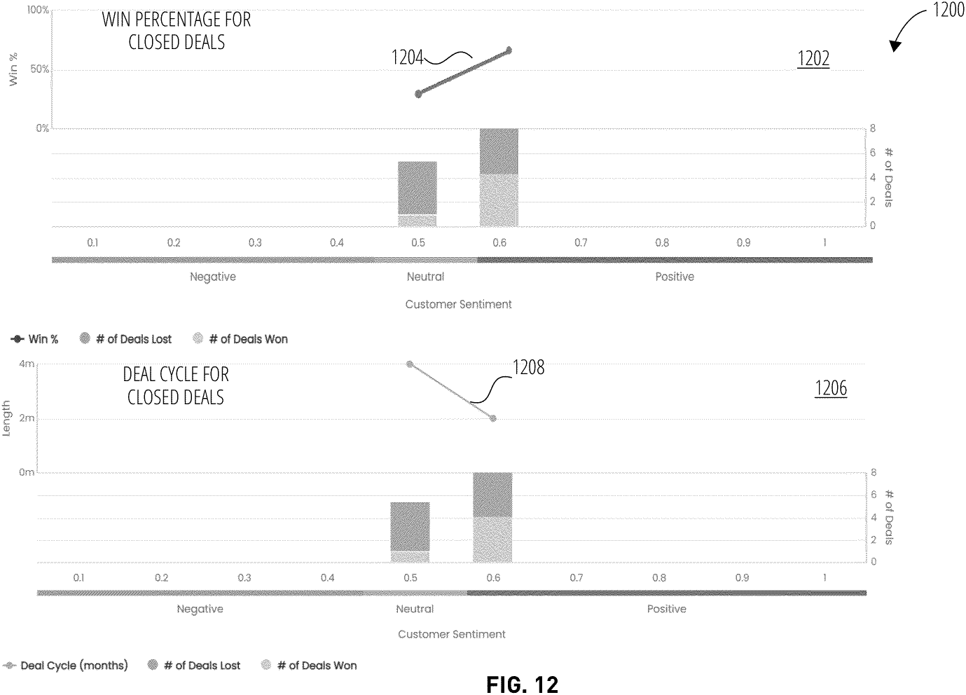

FIG. 12 illustrates a user interface 1200 depicting multi-deal graphics, for example, generated using one or more steps of the method 800 of FIG. 8, according to one or more embodiments. The user interface 1200 includes a win percentage graphic 1202 and a deal cycle graphic 1206.

The win percentage graphic 1202 shows an association between the customer sentiment for multiple deals on the X axis, and the number of deals on the lower Y axis, and a win percentage on the upper Y axis. The win percentage graphic 1202 of FIG. 12 shows that as the customer sentiment increases, the win percentage increases, and the number of deals won increases.

The deal cycle graphic 1206 shows an association between the customer sentiment for multiple deals on the X axis, the number of deals on the lower Y axis, and a time take for completing a deal (deal cycle) on the upper Y axis. The deal cycle graphic 1206 of FIG. 12 shows that as the customer sentiment increases, the deal cycle decreases, and the number of deals won increases.

While the embodiments discussed herein have been described with respect to the salesperson or customer representatives, the techniques described herein may be applied to other participants of the meetings or sales calls, and also in other contexts. Although various methods discussed herein depict a particular sequence of operations, the sequence may be altered without departing from the scope of the present disclosure, unless otherwise apparent from the context. For example, some of the operations depicted may be performed in parallel or in a different sequence that does not materially affect the function of the methods discussed herein. In some embodiments, some of the steps performed in a method may be optional or omitted. In other examples, different components of an example device or apparatus that implements the methods may perform functions at substantially the same time or in a specific sequence.

The methods described herein may be implemented in software, hardware, or a combination thereof, in different embodiments. In addition, the order of steps in methods can be changed, and various elements may be added, reordered, combined, omitted or otherwise modified. All examples described herein are presented in a non-limiting manner. Various modifications and changes can be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances can be provided for components described herein as a single instance. Boundaries between various components, operations and data stores are somewhat arbitrary, and particular operations are illustrated in the context of specific illustrative configurations. Other allocations of functionality are envisioned and can fall within the scope of claims that follow. Structures and functionality presented as discrete components in the example configurations can be implemented as a combined structure or component. These and other variations, modifications, additions, and improvements can fall within the scope of embodiments as defined in the claims that follow.

In the foregoing description, numerous specific details, examples, and scenarios are set forth in order to provide a more thorough understanding of the present disclosure. It will be appreciated, however, that embodiments of the disclosure can be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” etc., indicate that the embodiment described can include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Embodiments in accordance with the disclosure can be implemented in hardware, firmware, software, or any combination thereof. Embodiments can also be implemented as instructions stored using one or more machine-readable media, which may be read and executed by one or more processors. A machine-readable medium can include any mechanism for storing or transmitting information in a form readable by a machine (e.g., a computing platform or a “virtual machine” running on one or more computing platforms). For example, a machine-readable medium can include any suitable form of volatile or non-volatile memory.

In addition, the various operations, processes, and methods disclosed herein can be embodied in a machine-readable medium and/or a machine accessible medium/storage device compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium/storage device.

Modules, data structures, and the like defined herein are defined as such for ease of discussion and are not intended to imply that any specific implementation details are required. For example, any of the described modules and/or data structures can be combined or divided into sub-modules, sub-processes or other units of computer code or data as can be required by a particular design or implementation.

In the drawings, specific arrangements or orderings of schematic elements can be shown for ease of description. However, the specific ordering or arrangement of such elements is not meant to imply that a particular order or sequence of processing, or separation of processes, is required in all embodiments. In general, schematic elements used to represent instruction blocks or modules can be implemented using any suitable form of machine-readable instruction, and each such instruction can be implemented using any suitable programming language, library, application-programming interface (API), and/or other software development tools or frameworks. Similarly, schematic elements used to represent data or information can be implemented using any suitable electronic arrangement or data structure. Further, some connections, relationships or associations between elements can be simplified or not shown in the drawings so as not to obscure the disclosure.

This disclosure is to be considered as exemplary and not restrictive in character, and all changes and modifications that come within the guidelines of the disclosure are desired to be protected. Other technical features may be readily apparent to one skilled in the art from the following figures, descriptions, and claims.

While the foregoing is directed to embodiments of the present invention, other and further embodiments of the invention may be devised without departing from the basic scope thereof.

I/We claim:

1. A method for generating a cumulative sentiment score, the method comprising:
receiving, at an analytics server, for a first event having a first plurality of participants comprising a customer, video data and audio data for the customer;
extracting, for the customer, at least one of tonal information or text information from the audio data, and facial expression information from video data;
determining, from the at least one of the facial expression information, the tonal information or the text information, a first sentiment score for the customer for the first event; and
generating a first event graphic displaying an association between the first sentiment score and at least one deal parameter for the first event, wherein the at least one deal parameter is associated with a deal comprising the first event.

2. The method of claim 1, wherein the customer comprises a first plurality of customer representatives, and wherein the first sentiment score is an aggregate of the individual sentiment scores for each of the first plurality of customer representatives.

3. The method of claim 1, wherein the deal comprises a plurality of events comprising the first event and a second event, the method further comprising:
receiving, at the analytics server, for the second event having a second plurality of participants comprising the customer, video data and audio data for the customer;
extracting, for the customer, at least one of tonal information or text information from the audio data, and facial expression information from video data;
determining, from the at least one of the facial expression information, the tonal information or the text information, a second sentiment score for the customer for the second event; and
generating a second event graphic displaying an association between the second sentiment score and the at least one deal parameter for the second event.

4. The method of claim 3, wherein the customer comprises a second plurality of customer representatives, same or different as the first plurality of customer representatives, and wherein second sentiment score is an aggregate of the individual sentiment scores for each of the second plurality of customer representatives.

5. The method of claim 4, wherein the aggregate of individual sentiment scores for any of the first plurality of customer representatives or the second plurality of customer representatives is a weighted average, wherein at least one sentiment score of an individual customer representative is weighed higher than another sentiment score of another individual customer representative.

6. The method of claim 5, wherein the at least one sentiment score of the individual customer representative is weighed higher based on an input received from the multimedia device or the user device.

7. The method of claim 5, wherein the at least one sentiment score of the individual customer representative is weighed higher based on an input about the individual customer representative received from a customer relationship management (CRM) system.

8. The method of claim 4, determining a sentiment score for the deal by aggregating the first sentiment score and the second sentiment score.

9. The method of claim 8, wherein the aggregating includes weighing the first sentiment score higher than the second sentiment score.

10. The method of claim 9, wherein weighing the first sentiment score higher is based on an input received from the multimedia device or the user device.

11. The method of claim 8, further comprising generating a first deal graphic displaying an association between the sentiment score for the customer for the deal and the at least one deal parameter.

12. The method of claim 10, further comprising generating a second deal graphic displaying an association between a plurality of sentiment scores for a corresponding plurality of deals and the at least one deal parameter for the plurality of deals.

13. The method of claim 12, wherein the at least one deal parameter comprises at least one of a success rate of a deal, a deal cycle time, or a deal completion stage.

14. A method for generating a cumulative sentiment score for a deal comprising a plurality of events comprising a first event and a second event, the method comprising:
receiving, at an analytics server, for a first event having a first plurality of participants comprising a customer, video data and audio data for the customer;
extracting, for the customer, at least one of tonal information or text information from the audio data, and facial expression information from video data;
determining, from the at least one of the facial expression information, the tonal information or the text information, a first sentiment score for the customer for the first event;
receiving, at the analytics server, for the second event having a second plurality of participants comprising the customer, video data and audio data for the customer;
extracting, for the customer, at least one of tonal information or text information from the audio data, and facial expression information from video data;
determining, from the at least one of the facial expression information, the tonal information or the text information, a second sentiment score for the customer for the second event;
determining a sentiment score for the deal by aggregating the first sentiment score and the second sentiment score; and
generating a first deal graphic displaying an association between the sentiment score and at least one deal parameter comprising at least one of a success rate of a deal, a deal cycle time, or a deal completion stage.

15. The method of claim 14, wherein a plurality of sentiment scores are determined for a corresponding plurality of deals, the method further comprising generating a second deal graphic displaying an association between the plurality of sentiment scores for the corresponding plurality of deals and the at least one deal parameter for the plurality of deals.
